(19) United States
(12) Patent Application Publication
(10) Pub. No.: US 2003/0225555 A1
(43) Pub. Date: Dec. 4, 2003

(54) Component system design method and apparatus

(76) Inventors: Lalitha Gurumoorthy, East Peoria, IL (US); Wayne E. Harshberger II, Oswego, IL (US); Terry W. Keith, Minonk, IL (US); Gerard Moehn, Dunlap, IL (US); Frankie D. Mohr, East Peoria, IL (US); Terry L. Morris, Regenstauf (DE); Roger L. Wolschlag, East Peoria, IL (US)

Correspondence Address: Finnegan, Henderson, Farabow,, Garrett & Dunner, L.L.P., 1300 I Street, N.W., Washington, DC, 20005-3315, US

(21) Appl. No.: 10/158,473

(22) Filed: May 31, 2002

(51) Int. Cl. G06G 7/48

(52) U.S. Cl. 703/9

(57) ABSTRACT

A method is disclosed of designing a component system. Primary components of the system are established, the primary components having a desired connectivity. Secondary components are then established for connecting the primary components. A model may be generated connecting the primary components and the secondary components to achieve the desired connectivity. The secondary components may be automatically established and the compatibility of the primary and secondary components may be verified. A computer readable medium and a system for performing the described method are also provided.

### TECHNICAL FILED

The present invention relates generally to connecting components and, more particularly, to systems and methods for designing and/or updating a system including one or more elements connecting a plurality of components.

### BACKGROUND

Fluid lines such as hydraulic tubes and hoses are included in many products and systems. For example, an engine may include fluid lines to carry a liquid such as oil throughout the engine. Fluid lines may connect various parts of a product or system. For example, in a piece of machinery, a fluid line may connect a reservoir to a pump or a tank to a drain. In a product or system, multiple fluid lines may connect multiple parts or components. For example, in a home, many pipes may connect various plumbing components, including sinks, toilets, and drains.

The design of fluid lines takes into account many factors. Basic engineering principles may dictate the route of a fluid line connecting certain parts. Manufacturing guidelines may affect the desired route of a fluid line as part of a larger product or system. The design goals of a specific system or product may influence the design of a fluid line. For example, a fluid line may need to provide a desired fluid flow or pressure to increase a system's efficiency.

Furthermore, standards such as industry standards may include requirements for the design of fluid lines.

Currently, much of the fluid lines design process is performed by an individual. For example, a designer, such as an engineer, may develop a fluid lines design manually, either by manually drawing the fluid lines or by manually entering a design into a design software package. In either case, the designer should consider all of the factors in the design process, such as industry standards and design goals. The designer should take into account the various components to be connected and manually establish the fluid lines to achieve the desired connectivity. The multitude of considerations make the current design process tremendously burdensome for the designer.

Moreover, in current systems, a fluid lines designer must often perform manual calculations to test a design. For example, the designer may need to determine the pressure or fluid levels throughout a product or system to test the feasibility of a fluid lines design. These manual calculations further complicate the designer's task.

Another disadvantage of current systems is that there is little uniformity among fluid lines developed by different individuals. If several different designers work on a single product or system, they may each develop conflicting or inconsistent fluid lines plans. Further, in current systems, fluid lines designs may be inefficient. Poor designs may lead to problems with the components being connected or with the overall product or system. Additionally, the guidelines for a designer to follow (e.g., industry standards) are often not centrally located. Therefore, applicable guidelines may not be followed in every fluid lines design. Furthermore, changes in a product or system often require the design process to be repeated from the beginning. For example, if a damaged reservoir is replaced with a new reservoir having an outlet drain in a different location, the placement of any fluid line running from the outlet drain must be revised. In current systems, a designer must often start a new fluid lines design from scratch to accommodate such changes.

Systems exist for tailoring a product to meet a customer's needs. One such system is disclosed in U.S. Pat. No. 5,999,908 for Customer-Based Product Design Module. This patent discloses a system for designing and updating a product, such as a telephone or fax machine, based on user feedback. For example, a module may be embedded in a user's product to collect data about how the product is used. Periodically, the module may communicate the collected data to a central facility where modifications may be made to the product. The modifications are then sent to the module in the user's product to update the product. Although such a system tailors a product based on how a product is used, the system does not consider factors such as basic engineering principles, manufacturing guidelines, system design goals, or the compatibility between system components. Furthermore, current systems do not automatically respond to changes in system design or system components.

The present invention is directed to overcoming one or more of the problems or disadvantages associated with the prior art.

### SUMMARY OF THE INVENTION

It is to be understood that both the foregoing general description and the following detailed description are exemplary and explanatory only and are not restrictive of the invention as claimed.

One aspect of the disclosure involves a method of designing a fluid system, including establishing primary components of the fluid system, the primary components having a desired connectivity. Secondary components of the fluid system are automatically established based on the desired connectivity, and a model is generated connecting the primary components and secondary components to achieve the desired connectivity.

Another aspect of the disclosure involves a method of designing a system, including establishing primary components of the system, the primary components having a desired connectivity. Secondary components are established for connecting the primary components of the system. The compatibility of the primary components and secondary components is validated, and a model is generated connecting the primary components and secondary components to achieve the desired connectivity.

Yet another aspect of the disclosure involves a system for designing a fluid system including a processor and a memory. The memory includes a primary component designing module for establishing primary components of the fluid system, the primary components having a desired connectivity. Further, the memory includes a secondary component designing module for automatically establishing secondary components of the fluid system based on the desired connectivity. Still further, the memory includes a modeling module for generating a model connecting the primary components and secondary components to achieve the desired connectivity.

### BRIEF DESCRIPTION OF THE DRAWINGS

The accompanying drawings, which are incorporated in and constitute a part of this specification, illustrate an exemplary embodiment of the invention and together with the description, serve to explain the principles of the invention. In the drawings:

FIG. 1 is a block diagram of fluid lines design system consistent with an exemplary embodiment of the present invention; and

FIG. 2 is a flow chart of an exemplary embodiment of a method, consistent with the present invention, for designing fluid lines.

### DETAILED DESCRIPTION

Reference will now be made in detail to embodiments of the invention, examples of which are illustrated in the accompanying drawings. Wherever possible, the same reference numbers will be used throughout the drawings to refer to the same or like parts.

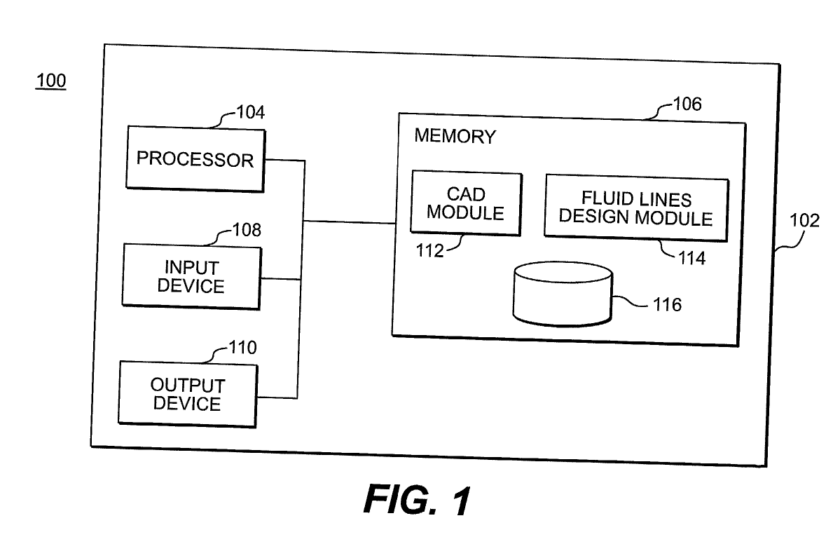

FIG. 1 illustrates a fluid lines design system consistent with an exemplary embodiment of the present invention. Fluid lines design system 100 may include a computer 102, which may include a processor 104, a memory 106, an input device 108, and an output device 110. Processor 104 may perform various aspects of fluid lines design based on instructions stored in memory 106. Processor 104 may receive information from input device 108 for use while designing fluid lines. Further, processor 104 may provide completed fluid lines designs or design information to output device 110.

Memory 106 may include a computer-aided design (CAD) module 112, a fluid lines design module 114, and a database 116. CAD module 112 may include instructions used by processor 104 to establish a system or product design. In one exemplary embodiment, CAD module 112 may be implemented using a schematic entry tool, such as Pro-Engineer™ software. In one embodiment, these elements (i.e., CAD module 112, fluid lines design module 114, and database 116) may be integrated into one element.

Fluid lines design module 114 may include instructions used by processor 104 for designing fluid lines based on input received via input device 108, such as a designer's preferences, and data stored in database 116, including design guidelines. Design guidelines may include system-dependent guidelines, such as the shape of a machine or the proximity of fluid lines to machine edges. Design guidelines may also include fluid line-dependent guidelines, such as tube diameters or hose pressure limits. Design guidelines may also include component-dependent guidelines, such as, for example, the number of connections available on a pump.

In one embodiment, design guidelines may include rules for routing fluid lines and data used to apply the rules. In this embodiment, the rules for routing fluid lines might be generic rules based on engineering standards. Fluid lines design module 114 may apply the rules by accessing data. The rules and data may be stored, for example, in database 116. In this way, the rules and/or data could be accessed by fluid lines design module 114, CAD module 112, or any other application.

For example, rules for routing tubes may include: minimum/maximum bend angle, minimum straight length between bends, maximum number of bends, minimum end straight length, maximum overall tube length, minimum/maximum bend radius, bend radius size given a maximum bend radius, valid bend radius given outside diameter and wall thickness, valid material specification given outside diameter and wall thickness, and valid end-type version. To design a tube, fluid lines design module 114 may need to apply one or more of these rules by looking for data or related rules stored in the database, such as the values or rules corresponding to the tube material or other aspect of the tube. For example, the value for minimum bend radius may be 50 millimeters for steel tubes and 25 millimeters for copper tubes. That is, for example, different materials may have different characteristics that may need to be accounted for. These characteristics may be incorporated into rules or data associated with rules. These values could be part of the data stored in the database used to apply the rules.

In one embodiment, there may be multiple types of rules, or a rule hierarchy. For example, there may be a default set of rules that applies to components and materials. A user may specify his own rules to supplement the default rules. The user may, if desired, specify a rule changing a default rule. For example, the default rule may state that the minimum bend radius for steel is 50 millimeters. The user may create a rule, or data to be applied to the rule, stating that the minimum bend radius for steel is 40 millimeters. The system would then apply the user's rule instead of the default rule. In one embodiment, the system may prompt the user whenever a user-defined rule or data conflicts with the default rule or data. In this manner, the user is notified about the potential conflict and may override the default rule.

Consistent with an exemplary embodiment of the present invention, the rules may be stored separately from the data used to apply the rules. This would enable a company to retain the rules while easily updating the data to reflect, for example, new products. The rules and/or data could be created according to a certain manufacturer's parts and stored in a database that could be sold to potential customers. This would encourage a potential customer to design systems using the manufacturer's parts, thereby increasing sales of the manufacturer's parts.

Fluid lines design module 114 may be implemented using software capable of interacting with CAD module 112. Alternatively, CAD module 112 and fluid lines design module 114 may be part of the same software package. Design guidelines may be stored locally on computer 102 or alternatively, may be accessible from a server or other computer (not shown) over a network, such as a local area network (LAN) or the Internet.

Database 116 may include data for use in designing products, systems, and fluid lines. This stored information may be accessed, for example, by CAD module 112, fluid lines design module 114, or a user via input device 108 and/or output device 110. The data may include, for example, industry or company-specific standards such as SAE standards, European standards, and Asian standards. In this way, systems consistent with the present invention may be used to design fluid lines for products and systems in any location. In one embodiment, company-specific standards may be removed from database 116 to create a generic industry database that may be shared throughout an industry without disclosing a company's proprietary information. Also in database 116 may be design guidelines, catalogs of available components, and formulas for automatic calculations performed in the design process. Database 116 may also store existing system or fluid lines designs that may be used in future design projects to save duplicate efforts.

In one embodiment, data stored in database 116 may be accessed by a centralized parts library, such as a corporate database. In this way, data about a new fluid lines design, including part numbers, couplings, etc., may be extracted from database 116 to automatically update the centralized parts library. Newly designed lines and products may thus be introduced to a corporate sales inventory in an automatic, seamless manner.

Input device 108 may receive instructions from a user, such as a designer, for the design of a fluid line. For example, input device 108 may receive information for establishing a product or system containing fluid lines. Input device 108 may include, for example, a keyboard or other data-entry device, a storage medium reader, such as a CD-ROM drive, or via a network, such as a LAN or the Internet.

Output device 110 may receive fluid lines designs or design information from processor 104 to be printed or displayed. Output device 110, for example, may print or display three-dimensional models of a fluid lines system. Furthermore, output device 110 may print or display two-dimensional drawings of the design, or may print or display other information, such as data tables, parts list, or a bill of materials for implementing a design. Output device 110 may include a display device, such as a monitor, or a printer. Alternatively, output device 110 may be connected to a storage device, such as a disk drive, for transferring the drawings and/or data to a storage medium, or to a network, such as a LAN or the Internet, for transferring the drawings and/or data to another computer or server.

Computer 102 may be implemented in various environments to provide tools for designing fluid lines. Computer 102 may include hardware specifically constructed for performing various processes and operations of the invention or may include a general purpose computer or computing platform selectively activated or reconfigured by program code to provide the necessary functionality.

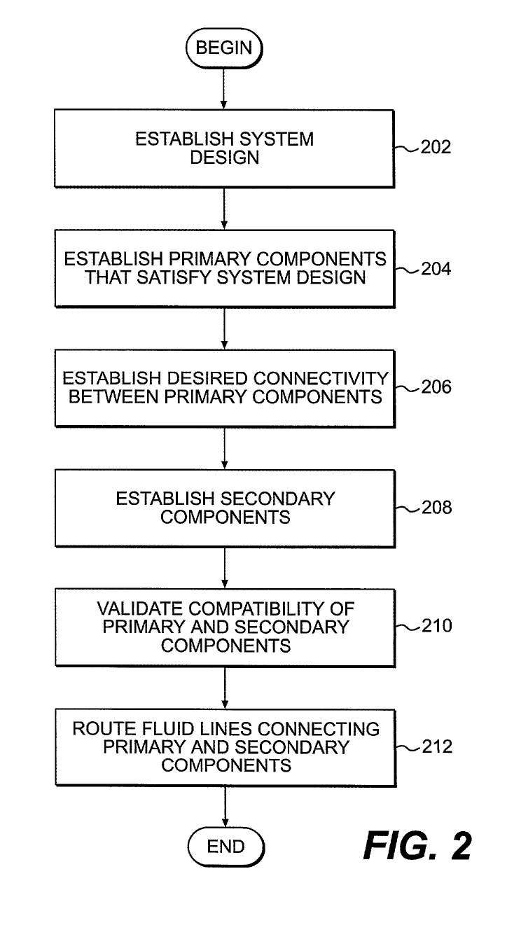

FIG. 2 illustrates a flow chart of a method for designing fluid lines consistent with an embodiment of the present invention. Instructions for a process to design fluid lines may be included in fluid lines design module 114, CAD module 112, or another module interacting with system 100, to be performed by processor 104. First, a system design is established (step 202). A system may be a product, such as a piece of machinery, a part of a larger product, or any collection of primary and secondary components. In one exemplary embodiment, the system may be a machine that includes one or more fluid lines; however, the methods and systems described herein are equally applicable to any system that may require connections between components. The system design may include the topography of the system, e.g., the shape of a machine, and/or functional requirements, e.g., desired fluid flow, fluid pressure, etc.

Fluid lines such as hydraulic tubes and hoses are included in many products and systems. For example, an engine may include fluid lines to carry a liquid such as oil throughout the engine. Fluid lines may connect various parts of a product or system. For example, in a piece of machinery, a fluid line may connect a reservoir to a pump or a tank to a drain. In a product or system, multiple fluid lines may connect multiple parts or components. For example, in a home, many pipes may connect various plumbing components, including sinks, toilets, and drains.

Based on the system design, primary components are established (step 204). A primary component may be generally described as an element of a system having a primary function other than providing connectivity and a secondary component may be generally described as anything that facilitates connection of two or more primary components. Primary components may include, for example, pumps, tanks, reservoirs, cylinders, and valves. The system design may be established using, for example, CAD module 112 or input received via input device 108. In one embodiment, the primary components may be selected from a parts library that may include, for example, company-specific standard parts or industry standard parts, e.g., IEEE or ANSI parts. The parts library may be stored, for example, locally in database 116 or remotely in a corporate database accessed via a network. In one embodiment, primary components may be automatically selected based on system design specifications.

For the primary components, the desired connectivity is established (step 206). For example, to satisfy the system diagram, a pump may need to be connected to a valve that in turn is connected to a tank. The desired connectivity may be established, for example, using input received via input device 108. Alternatively, the desired connectivity may be generated in an automated manner based upon design guidelines associated with the primary components. For example, system guidelines may be to connect a pump outlet to one or more valves, to the input of a tank, etc. System guidelines may be that a category of components, such as high capacity hoses, is associated with certain types of couplings, connectors, or end processes. These may include, for example, braised or welded end processes, mechanical joints, O-ring face seals, 37 degree flares, etc.

Based on the primary components, secondary components are established to achieve the desired connectivity (step 208). Secondary components may include, for example, couplings, hose assemblies, joints, tubes, hoses, harnesses, terminals, wires, splices, fuel injectors, etc. Secondary components may include processes (e.g., end processes) such as welding, braising, an mechanical joints. The secondary components may be established by a user who accesses a parts library stored in database 116 to select the secondary components. The secondary components may be automatically established or established in a semi-automated manner. In one embodiment, a table of existing hose assemblies may be stored in database 116 and updated periodically. A designer may use search criteria, such as length, material, or pressure limits, to search for an existing hose assembly. The search results may include, for example, the cost of each available hose assembly, thereby enabling the designer to choose a cost-effective existing hose assembly. One skilled in the art will recognize that this search feature could be used for any type of component.

In another embodiment, fluid lines design module 114 may generate recommended secondary components based on the primary components and information stored in database 116. The secondary components may be automatically established or maybe recommended to a user who is prompted for acceptance or rejection. In yet another alternative embodiment, fluid lines design module 114 may select secondary components based on standard fluid lines designs stored in database 116. This may promote consistency in fluid lines designed by different designers and may reduce redundant design work by reusing designs created in the past.

The compatibility of the primary and secondary components is then validated (step 210). This compatibility check may be run automatically, for example, by fluid lines design module 114 each time a component is selected or once primary and secondary components have been established. In one embodiment, a user may request via input device 108 for fluid lines design module 114 to perform a compatibility check at any point in the design process. The compatibility check may determine whether selected primary and secondary components are compatible. For example, fluid lines design module 114 may consult defined compatibility guidelines to determine whether the couplings to a selected valve and pump have compatible hose diameter requirements. In one embodiment, fluid lines design module 114 may suggest alternative components of fluid lines if the compatibility check does not yield a desired result. This results in more efficient systems because incompatible components are detected at an early stage in the design process.

Next, fluid lines will be routed to connect primary and secondary components (step 212). Fluid lines may be routed based on the selected components and any aspects of the system design. For example, the system design may include the shape of a machine along with the placement of components within the machine. In one embodiment, when fluid lines are routed, the should avoid colliding with components and other fluid lines while still connecting the proper components. In one embodiment, structural guidelines may be incorporated to establish how to route fluid lines relative to a structure associated with the fluid system and also to route fluid lines relative to other components associated with the structure or fluid system. For example, one rule or guideline may indicate how far from the bulkhead a fluid line should be run (e.g., on the bulkhead, one inch off the bulkhead, etc.). In addition, the bulkhead may have areas where fluid lines are desirably routed. These structural guidelines would provide the guidelines/rules. Therefore, these guidelines may be used when routing fluid lines.

Fluid lines may be routed based on any number of considerations, including material, stiffness, diameter, maximum pressure, guard sheathing, gravity, fluid density, etc. Current systems use four data structures—arc, line, NURBS, and spline—to model fluid lines. In an embodiment of the present invention, a combination of these data structures may be used to produce more accurate routing diagrams. Precise modeling enables a designer to accurately analyze, for example, fluid lines routed between dynamic components, such as the boom and stick assembly of an excavator. In another embodiment, the fluid lines may be modeled manually by a designer.

The fluid lines may be routed automatically by fluid lines design module 114 or a designer may choose to route one or more fluid lines manually. The fluid lines design process may be iterative in nature, involving feedback from the designer that may refine the specifics of a system design or the considerations in selecting components and routing fluid lines.

The routing of fluid lines may be based in part on design guidelines that provide general recommendations, rules, and/or standards for designing the fluid lines. In one exemplary embodiment, guidelines may include recommendations for the routing of one or more fluid lines based on past fluid lines designs. Design guidelines may be stored, for example, in database 116 or may be created by prompting the designer to answer one or more questions. Alternatively, guidelines may be stored at a centralized location, such as a server (not shown), and accessed during the process of fluid lines design. In this embodiment, use of uniform guidelines may be ensured. Further, in this embodiment, updating of guidelines is a simpler process since all guidelines are stored in one location.

Fluid lines may be modeled or drawn based on information transferred from a schematic of the system. For example, in one exemplary embodiment, the system design as described above may be diagrammed using fluid lines design module 114 and/or CAD module 112. Design guidelines may be retrieved, e.g., from database 116, to assist in defining the schematic. A schematic of a system may include, for example, engineering specifications, component operating procedures, hose/tube diameters, etc. In one embodiment, a system schematic may be used as a basis for creating a model of the system.

In an embodiment of the present invention, a fluid lines design may be automatically updated to allow for changes to an overall system or product, replacement components, changed design goals, etc. For example, an existing system may include a pump that is redesigned. The redesigned pump may have its inlet valve in a new location. To fit the redesigned pump into the existing system, fluid lines connected to the pump may need to be re-routed to connect to the newly located inlet valve. Accordingly, fluid lines design system 100 may automatically redesign the fluid lines to accommodate the new component.

In one embodiment, fluid lines design module 114 may automatically reroute all fluid lines affected by a change to a system, product, or component. In another embodiment, when a component or other aspect of a product or system changes, a designer may input data about the change via input device 108. The data may include, for example, the name or number of a new component, a new shape of a machine, or a new location for a component. Fluid lines design module 114 may determine new requirements for fluid lines based on the data. For example, if a component has been moved, fluid lines design module 114 may calculate the distance to the new location of the component. Fluid lines design module 114 may perform compatibility checking, e.g., to determine whether other existing components and/or fluid lines should be changed. Fluid lines design module 114 may recommend new routing for the fluid lines affected by the change or may automatically implement the proposed new routings. In one embodiment, several design options may be presented, e.g., using different types of fluid lines, different length tubes, or different diameter fittings. The designer may select a fluid lines design or fluid lines design module 114 may automatically choose a design, for example, based on cost or availability of parts. In this way, fluid lines designs can easily adapt to changes in products, systems, or even individual components, reducing redesign time and costs.

In an embodiment of the present invention, calculations involved in the fluid lines design process may be performed automatically, saving time and improving accuracy. Formulas and instructions used to perform these calculations may be stored, for example, in database 116. For example, when a fluid line is routed, a designer may need to know the internal volume of related components such as tubes, hoses, pumps, filters, etc. These calculations may be used to determine the amount of fluid a hydraulic system will use, thereby enabling the designer to select appropriately-sized reservoirs, filters, sumps, etc. For example, an oil pump containing a fluid line may be designed by a designer. Fluid lines design system 100 may then calculate the amount of oil that will fill the pump and associated fluid lines, perhaps by calculating the volume and/or weight of oil needed. This information enables a designer to select a component such as a tank or reservoir in a size that will produce the most efficient system or product.

In another example, a designer may need to know the pressure drops throughout a system to ensure that the components and fluid lines meet specified requirements. For example, a system such as a cooling system of an engine may have various pressure caps at various points in the system. Fluid lines that connect one component to the next may include valves to lower or raise pressure to ensure that the proper pressure reaches each component in the system. Accordingly, fluid lines design system 100 may automatically calculate the pressure levels and drops for a fluid lines design using, for example, instructions and formulas stored in database 116. This makes a designer's task less burdensome and increases the accuracy of the calculations, producing more precise systems and products.

The results of calculations maybe reported via output device 110 or may be used by CAD module 112 or fluid lines design module 114. The calculations performed by fluid lines design system 100 may be consulted, for example, as part of the initial system design phase, as factors in selecting system components, or as part of a compatibility check. The calculations may also be used as part of the automatic updating of existing designs.

Industrial Applicability

The disclosed system enables a user to design, route, and validate fluid lines. Fluid lines may include, for example, tubes, hoses, guarding material, couplings, etc. Fluid lines may be used to connect components of a system. Components may include, for example, pumps, reservoirs, cylinders, etc. A system may include components connected by a fluid line, such as a reservoir and a pump connected by a hose. Consistent with an embodiment of the present invention, a system may contain any number of components and any number of fluid lines.

In addition to fluid lines, systems and methods consistent with the present invention may be used to design other types of lines, including but not limited to electric wires, bundles and harnesses, cabling mechanisms, and linkages and rods. For example, in one embodiment, handrails, such as handrails on large machinery, may be routed. Pipes and brackets may be components of a handrail. A crushed end, i.e., a crushed portion of pipe with a hole, may connect a handrail to a piece of equipment. A designer may use fluid lines design system 100 to design and model handrails, handles, and brackets. For example, different handrail components and connectors, such as crushed ends, tube flares, and guard rails may be stored in a parts library in database 116 along with guidelines for creating completed handrails.

Systems and methods are thus provided to automate and streamline the design process of, for example, a fluid system. By establishing components of a system or product, verifying the compatibility of selected components, and consulting applicable guidelines, it is possible to improve the design of component systems such as fluid lines systems.

The burden on a designer is reduced by the automation of design tasks, including selecting system components, ensuring the compatibility of system components, and performing calculations necessary to the design process. Furthermore, automated design promotes uniformity among fluid lines developed by different individuals and more efficient products and systems. Centralized design guidelines may be more uniformly applied, resulting in more reliable products and systems. Also, changes in a product, system, or component may be accommodated with little additional design effort.

As used throughout this description, automatically means without an operator performing the task. Tasks performed automatically, however, may require an input from an operator in order for the task to proceed and therefore may be automated or semi-automated. Further, automatically does not necessarily mean occurring immediately. In addition, an automated manner or technique may also include semi-automated or fully automatic techniques. Automated does not necessarily mean occurring immediately.

It will be readily apparent to those skilled in this art that various changes and modifications of an obvious nature may be made, and all such changes and modifications are considered to fall within the scope of the appended claims. Other embodiments of the invention will be apparent to those skilled in the art from consideration of the specification and practice of the invention disclosed herein. It is intended that the specification and examples be considered as exemplary only, with a true scope and spirit of the invention being indicated by the following claims and their equivalents.

What is claimed is:

1. A method of designing a fluid system, the method comprising:
establishing primary components of the fluid system, the primary components having a desired connectivity;
establishing secondary components of the fluid system in an automated manner, based on the desired connectivity; and
generating a model connecting the primary components and secondary components to achieve the desired connectivity.

2. The method of claim 1, wherein the model is generated automatically.

3. The method of claim 1, wherein the model is partially generated manually.

4. The method of claim 1, further including:
confirming the desirability of the secondary components.

5. The method of claim 1, further including:
verifying the compatibility of the primary components and secondary components.

6. The method of claim 5, wherein the compatibility is verified using compatibility guidelines.

7. The method of claim 1, wherein the step of automatically establishing secondary components includes the steps of:
generating a plurality of alternative secondary components; and
selecting secondary components of the fluid system from the plurality of alternatives based on selection criteria.

8. The method of claim 1, further including:
determining a change in a primary component of the fluid system; and
automatically updating the secondary components to accommodate the changed primary component.

9. The method of claim 1, wherein at least one primary component is selected from a parts library.

10. The method of claim 9, wherein at least one secondary component is selected from a parts library.

11. The method of claim 9, wherein the primary components are established by comparing functional requirements of the fluid system with specifications of the primary components available in the parts library.

12. The method of claim 1, wherein the generated model connects the primary components and secondary components based at least in part upon physical characteristics of a structure for which the fluid system is designed.

13. The method of claim 1, wherein the step of automatically establishing secondary components includes the steps of:
generating a plurality of recommended secondary components; and
selecting secondary components of the fluid system from the plurality of recommended secondary components.

14. The method of claim 1, wherein the generated model connects the primary components and secondary components based upon physical characteristics of the secondary components.

15. The method of claim 1, wherein the secondary components are established at least in part based upon structural guidelines.

16. A method of updating a fluid system, the method comprising:
establishing primary components of the fluid system, the primary components having a desired connectivity;
establishing secondary components for connecting the primary components of the fluid system;
generating a model connecting the primary components and the secondary components to achieve the desired connectivity;
determining a change in a primary component of the fluid system; and
automatically updating the secondary components to accommodate the changed primary component.

17. The method of claim 16, further including:
validating the updated secondary components and the changed primary component.

18. A method of designing a fluid system, the method comprising:
establishing at least one primary component of the fluid system;
establishing at least one secondary component for connecting to the at least one primary component; and
performing a calculation in an automated manner, based on the established at least one primary component and the established at least one secondary component.

19. The method of claim 18, further including:
performing additional design of the fluid system based upon the performed calculation.

20. The method of claim 19, wherein the additional design performed includes:
selecting an additional primary component.

21. The method of claim 19, wherein the additional design performed includes:
selecting an additional secondary component.

22. The method of claim 19, wherein the additional design performed includes:
selecting an alternative primary component to the established at least one primary component.

23. The method of claim 19, wherein the additional design performed includes:
selecting an alternative secondary component to the established at least one secondary component.

24. The method of claim 19, wherein the additional design performed includes:
modeling the fluid system.

25. The method of claim 18, wherein the calculation involves determining a fluid volume.

26. The method of claim 18, wherein the calculation involves determining a pressure level.

27. A method of designing a system, the method comprising:
establishing primary components of the system, the primary components having a desired connectivity;
establishing secondary components for connecting the primary components of the system;
verifying the compatibility of the primary components and secondary components; and
generating a model connecting the primary components and secondary components to achieve the desired connectivity.

28. The method of claim 27, wherein the step of establishing secondary components includes the steps of:
generating a plurality of alternative secondary components; and
selecting secondary components of the system from the plurality of alternatives based on selection criteria.

29. The method of claim 27, further including:
determining a change in a primary component of the system; and
automatically updating the secondary components to accommodate the changed primary component.

30. The method of claim 27, wherein the system is a fluid system.

31. The method of claim 27, wherein the system is a handrail system and wherein the desired connectivity is based on connecting a handrail to a piece of machinery.

32. A computer-readable medium including instructions for designing a fluid system, the instructions comprising:
establishing primary components of the fluid system, the primary components having a desired connectivity;
automatically establishing secondary components of the fluid system based on the desired connectivity; and
generating a model connecting the primary components and secondary components to achieve the desired connectivity.

33. The computer-readable medium of claim 32, the instructions further including:
verifying the compatibility of the primary components and secondary components.

34. The computer-readable medium of claim 32, wherein the instruction for automatically establishing secondary components includes the steps of:
generating a plurality of alternative secondary components; and
selecting secondary components of the fluid system from the plurality of alternatives based on selection criteria.

35. The computer-readable medium of claim 32, the instructions further including:
determining a change in a primary component of the fluid system; and
automatically updating the secondary components to accommodate the changed primary component.

36. The computer-readable medium of claim 32, the instructions further including:
automatically performing a calculation based on at least one of the primary components and at least one of the secondary components.

37. A system for designing a fluid system, the system comprising:
a processor;
a memory including:
a primary component designing module for establishing primary components of the fluid system, the primary components having a desired connectivity;
a secondary component designing module for establishing secondary components of the fluid system in an automated manner, based on the desired connectivity; and
a modeling module for generating a model connecting the primary components and secondary components to achieve the desired connectivity.

38. The system of claim 37, wherein the primary component designing module and the modeling module are part of a common software package.

39. The system of claim 37, wherein the secondary component designing module and the modeling module are part of a common software package.

40. The system of claim 37, wherein the primary component designing module is a computer-aided design module.

41. The system of claim 37, wherein the secondary component designing module is a fluid lines design module.

42. The system of claim 37, wherein the secondary component designing module further verifies the compatibility of the primary components and secondary components.

43. The system of claim 37, wherein the secondary component designing module further generates a plurality of alternative secondary components, and selects secondary components of the fluid system from the plurality of alternatives based on selection criteria.

44. The system of claim 37, wherein the secondary component designing module further determines a change in a primary component of the fluid system, and automatically updates the secondary components to accommodate the changed primary component.

45. The system of claim 37, further including a database for storing a catalog of primary components and secondary components.
